(19) United States
(12) Patent Application Publication
(10) Pub. No.: US 2005/0132904 A1
(43) Pub. Date: Jun. 23, 2005

(54) Process for packaging products in roll and associated cylinder

(75) Inventors: Michel Basler, Issenheim (FR); Sebastien Jeannot, Bischwihr (FR)

Correspondence Address: PATENT GROUP GA030-43;GEORGIA-PACIFIC CORPORATION, 133 PEACHTREE STREET, N.E., ATLANTA, GA, 30303-1847, US

(73) Assignee: Georgia-Pacific France, Courbevoie Cedex (FR)

(21) Appl. No.: 10/982,173

(22) Filed: Nov. 4, 2004

(30) Foreign Application Priority Data
Nov. 5, 2003 (FR) 03 12998

(51) Int. Cl. B31F 1/07

(52) U.S. Cl. 101/23

(57) ABSTRACT

This invention relates to a process for manufacturing and packaging rolls of tissue paper, wherein at least one sheet of paper is embossed in an embossing unit that includes an engraved embossing cylinder that includes at least a first zone with a first embossing motif and a second zone with a second embossing motif that is different from the first. Rolls are obtained whose sheet is embossed according to the first motif and rolls are produced whose sheet is embossed according to the second motif. With this procedure, packs that contain rolls having different designs are produced in a simple fashion.

We claim priority to French Patent Application Number 03 12998 filed Nov. 5, 2003, the entire contents of which are hereby incorporated by reference.

### FIELD OF INVENTION

This invention relates to the area of products for sanitary or home use on rolls and focuses in particular on rolls of tissue paper or cellulose wadding that are packaged under film. For example, the rolls of paper are intended for use as toilet paper or all-purpose paper towels.

### BACKGROUND OF THE INVENTION

The rolls of toilet paper or paper towels are formed by unwinding from a continuous sheet, whereby the sheet is optionally precut into successive lengths. The sheet itself is composed of one or more superimposed plies, whereby at least the outer, top ply is embossed with a decorative motif.

These rolls are packaged in groups of two or more, i.e., they are wrapped in protective packaging for retail sale. The invention relates in particular to the packaging of rolls in a film that is transparent over at least a portion of its surface where the design is supposed to show through.

The technique for transforming a sheet of tissue paper coming out of the paper-making machine into rolls that are ready for sale consists of several stages that are found in the majority of manufacturing lines.

The sheet is unwound from a parent roll that can be, for example, 2.6 m wide; it is transported to an embossing unit in which the sheet is embossed and optionally assembled with multiple plies to form a multi-ply sheet. The sheet is then wound around a winding tube that is of the same width as the parent roll so as to form a roll whose diameter corresponds to the final diameter of the rolls that are to be produced. This roll, which is called a log in the industry, is then cut into individual rolls. The latter are placed on conveyor belts and sent to a sorting station where they are separated into batches of successive rolls to be packaged under film.

For example, EP Patent 995 681, which is owned by the applicant, describes a unit for the manufacture and packaging of such rolls.

More specifically, this document discloses a unit for the manufacture and packaging of products in rolls in series, whereby the unit consists of, from upstream to downstream relative to the direction in which the rolls move forward in the unit: a cutting station that is designed to cut the logs into successive batches, whereby there may or may not be spaces between them, of multiple rolls of smaller length and a conveyor that is designed to carry the batches of rolls from the cutting station to a distribution station that in turn distributes the rolls batch by batch to multiple packaging stations.

The problem that the invention seeks to solve relates to the way in which the packs of multiple rolls, at least two of which have different embossed designs, are made.

To make these different designs, one solution would consist in embossing the paper on units equipped with different embossing cylinders, whereby each embossing cylinder would be engraved with a different motif. Logs with different designs would thus be produced.

In the device presented above, unless the logs are all identical in design and are cut simultaneously, the distribution station could ultimately wind up with a mixture of different rolls in the packages.

This solution, however, is costly. It requires a very complex kind of management of the rolls that is difficult to envision in a high-speed industrial installation having a satisfactory output. Between the embossing units and the packaging units, the installations have towers that form a temporary storage area. Managing different logs in these towers would certainly not be an economically advantageous solution.

### SUMMARY OF THE INVENTION

The goal of this invention is to provide a simple and, more importantly, economical solution to the problem mentioned above.

According to the invention, the process for manufacturing and packaging rolls of woven paper in which at least one sheet of paper is embossed in an embossing unit that includes an engraved embossing unit, the sheet is wound up into logs, the logs are cut into individual rolls, and the rolls are sent to a packaging unit, is characterized by the fact that said embossing cylinder includes at least first zones with a first embossing motif and second zones with a second embossing motif that is different from the motif of the first zones, whereby individual rolls are produced with a sheet that is embossed according to the first motif and individual rolls are obtained whose sheet is embossed according to the second motif.

More specifically, the first and second zones form separate strips that are transverse to the axis of the cylinder. According to one specific characteristic, the strips are separated in the axial direction by a so-called intermediate zone, whereby the cutting of the logs in the embossed sheet is done at these intermediate zones. According to another specific characteristic, the width of each of the zones in the axial direction is smaller than the width of the above-mentioned individual rolls.

The engraved cylinder can include third, fourth, etc., zones with as many different motifs as the width of the parent sheet will accommodate. For example, for a sheet coming off of a parent roll 260 cm wide, the cylinder can hold up to 26 zones with different motifs provided that each individual roll is 10 cm wide.

According to one embodiment, the intermediate zone does not contain an embossing motif.

According to another embodiment, the intermediate zone is embossed and contains in particular an embossing motif that consists of protrusions arranged according to alignments or else an embossing motif that includes micro-protrusions that are distributed at a ratio of at least 30 micro-protrusions per cm², whereby the two motifs are either separate or combined.

In particular, the motif of the intermediate zone constitutes a background motif for at least one of the first or second zones. “Background motif” is defined as a motif or a motif element that the zones or group of zones have in common.

According to another characteristic, the width of the intermediate zone in the axial direction of the cylinder is between 1 and 40 mm, and preferably between 5 and 30 mm.

According to another characteristic, the sum of the width of the first zone and that of the intermediate zone or the sum of the width of the second zone and that of the intermediate zone is essentially equal to that of an individual roll.

Thus, the cutting of the rolls can be done with a certain amount of tolerance with respect to the relative position of the cutting blades in terms of the length of the logs. The cutting is done between the different motifs, regardless of how they are arranged or oriented on the log. This characteristic makes it possible to be certain of cutting the logs between a first and second zone. Finally, it is also ensured that rolls will be produced that will have a single motif; this single motif per roll corresponds to one of the first, second, or n-th motif of the embossing cylinder.

The rolls obtained are aesthetically pleasing and ensure a good presentation.

From a single log-cutting machine, it is possible to produce packaged packs that consist of multiple rolls that have different embossing motifs, unlike the solution where they would be produced by multiple machines. This ensures considerably reduced costs in both production and investment.

The solution of the invention thus makes it possible, and simple, without having to install any means of managing the logs produced with different motifs, to produce packaged packs that consist of multiple rolls having different embossing motifs.

According to another advantage of the process, the edges of the sheets are kept from separating when they are composed of multiple plies. It is sufficient to ensure that the sheets are bonded together at least in the intermediate zone. The bonding of the plies is generally done by gluing the plies together along the embossing reliefs. The unembossed zones are not glued.

Moreover, with background micro-embossing, a uniform distribution of the embossing forces over the width of the sheet is ensured.

According to another characteristic, the logs are temporarily stored before they are cut into individual rolls.

According to another characteristic, series of individual rolls are produced from a single log.

This means that it is not necessary for production to be continuous. This stage of storage before the logs are embossed and cut into rolls makes it possible, in fact, to manufacture a certain number of logs and then, when it becomes necessary to produce rolls, to go back and cut them in accordance with the invention.

This modulation in the manufacture process is very advantageous because on-line manufacturing is avoided.

### BRIEF DESCRIPTION OF DRAWINGS

Other characteristics, details, and advantages of the invention will be better understood from a reading of the following description, which is meant to be illustrative and in no way limiting and which refers to the attached drawings, where:

FIG. 1 is an illustration of a portion of an installation for the manufacture and packaging of products in rolls;

FIGS. 2A and 2B are illustrations of the downstream portion of an installation for the production and packaging of products in rolls, from the cutting of the logs to the packaging of the rolls, according to two variants:

FIG. 3 is an example of an embossing motif on the logs, according to the invention;

FIG. 4 is a schematic representation of an embossing installation.

### DETAILED DESCRIPTION OF THE INVENTION

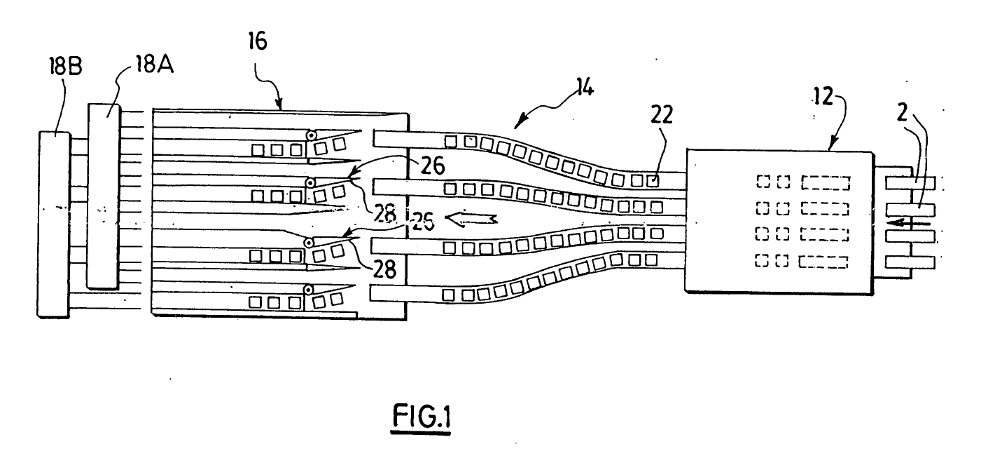

FIG. 1 makes it possible to illustrate the main stages, which are known, of the manufacturing of products in rolls.

Moving from upstream to downstream relative to the direction in which the products move forward in the manufacturing process, there are located a cutting station and a conveyor.

The purpose of the cutting station 12 is to cut successive logs 2, which are very long and have a given diameter, into successive series of multiple rolls 22 of shorter length. For example, a log 260 cm long is cut into 26 rolls 22.

The conveyor 14 carries the series of rolls 22 from the cutting station 12 to a distribution station 16, which distributes the rolls 22 to two packaging stations 18A and 18B.

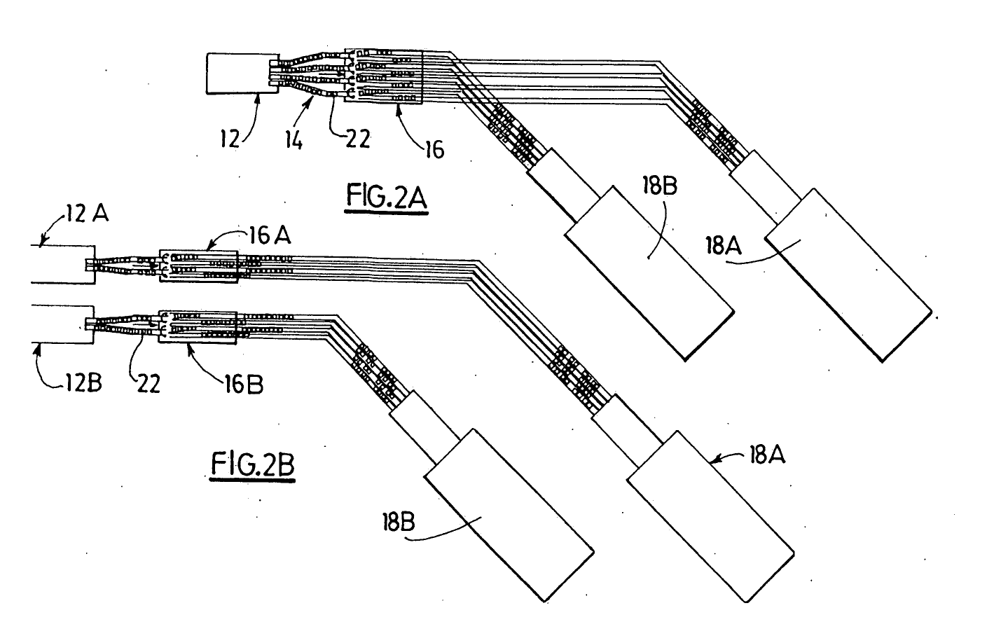

FIGS. 2A and 2B each illustrate an embodiment, one of which calls for one cutting unit and the other calls for two cutting units.

According to FIG. 2A, the installation includes a single cutting unit 12, which makes it possible to cut four logs (not shown) simultaneously, thus producing at the output four series of rolls that are distributed at the distributor 16 onto 2×four series of rolls that are sent to two packaging units 18A, 18B.

According to FIG. 2B, the installation includes two cutting units 12A, 12B, for simultaneously cutting two series of logs: in this case 2×two logs 2.

From each cutting unit 12A, 12B there thus emerge to series of rolls 22, each of which is sent to a distributor 16A, 16B, which alternately sends the series of rolls 22 to one rail or another, whereby the rails make it possible to send rolls to a packaging unit 18A, 18B.

The object of this invention is a process that is intended to produce packaged packs that contain multiple rolls that are decorated according to different embossing motifs.

The rolls are arranged randomly or pseudo-randomly, such that the packs all appear different since there are a very large number of possible combinations.

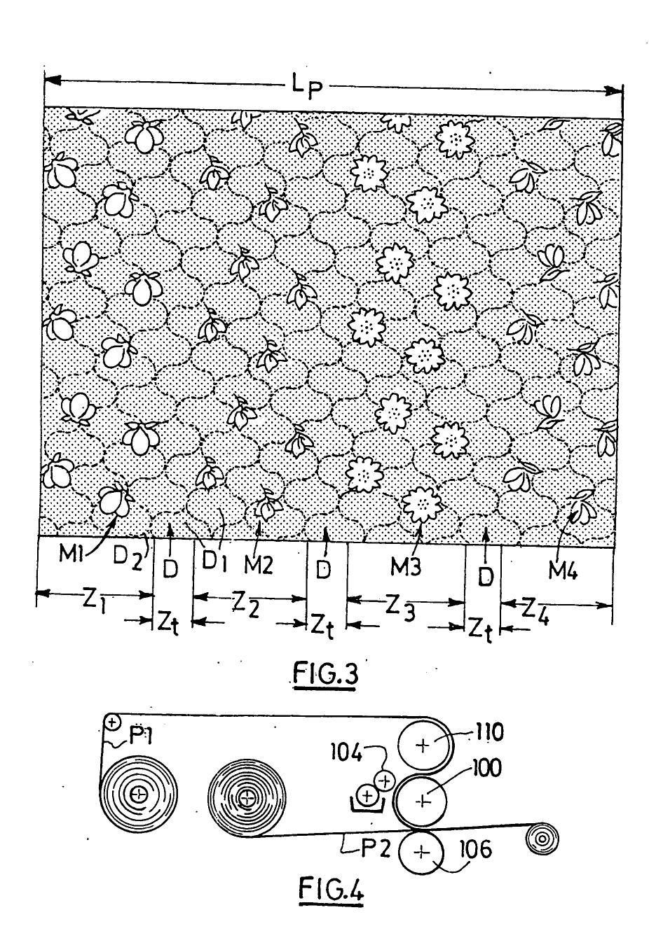

This object is achieved in a simple way by the process according to the invention, which preferably but not exclusively, uses an embossing cylinder 100 that is engraved according to a motif such as that shown in FIG. 3.

This figure shows the developed surface of a portion of cylinder 100. In this case the distance Lp, measured in the direction of the axis of the cylinder, corresponds to the width of four individual rolls.

Over this distance, the embossing includes a first zone Z₁, which is shaped as a strip perpendicular to the axis of the cylinder, with a first motif M₁, a second zone Z₂, also in the shape of a strip, with a second motif M₂, which is different from the first, and between them a zone Zₜ, a transition zone or so-called intermediate zone, which in this case has a motif D that is different from the other motifs. The main motifs M₁ and M₂ are arranged according to strips of width 1. The width 1 is less than that of an individual roll, which is usually 10 cm. The motif D is composed of a background that consists of micro-protrusions D1 and individual protrusions arranged according to alignments D2.

The diagram in FIG. 3 shows two other zones, Z₃ and Z₄, which also have different motifs M₃ and M₄. Between these zones, and according to this embodiment, the intermediate zones Zₜ are all identical and have the same motif D. This motif D also constitutes a background motif that runs through all of motifs M₁ to M₄. These motifs are flowers distributed along strips. Of course, other designs are included within the framework of the invention, whose object is not the motifs in and of themselves.

It is advantageous for motif D to be of the microembossing type, i.e., to be composed of protrusions that are regularly distributed, at least in part, over the surface at a ratio of at least 30 per cm². The density can be even higher, up to 100 per cm² in actual manufacturing. The size of the protrusions is directly tied to the density of the motif. In this embodiment, this motif is supplemented by a network of protrusions that form undulations.

Of course, the sequence of motifs over the machine width can take on innumerable forms. A great deal of freedom is thus advantageously allowed in the choice of motifs and in their arrangement with respect to another on the logs.

In all cases, it is necessary to have at least two different motifs Mᵢ over the machine width.

According to another embodiment, not shown, motif D may not be present in the third intermediate zones. The intermediate zones Zₜ allow a certain degree of tolerance in terms of the position of the cutting devices between a first zone Z₁ and a second zone Z₂. Taking into account the variation in certain manufacturing parameters, the logs can be slightly displaced from the theoretical position with respect to the cutting devices. The intermediate zone Zₜ thus makes it possible to compensate for this possible displacement and to produce rolls on which only a single motif appears.

The zones Zₜ preferably cover a width of between 1 and 40 mm, and more preferably between 5 and 30 mm.

The motif in these zones Zₜ may consist of straight or curved lines and/or alignments, for example, points or picots. In the specialized vocabulary of the field, the alignments are currently referred to as networks.

The networks perform a gluing function when multiple plies have to be glued together; in particular, a dye can be added to the glue.

According to an additional characteristic of the invention, micro-embossing can be done over almost the entire surface of the log. According to another characteristic, this micro-embossing is advantageously done before the motifs are embossed. The sheet is embossed before it reaches the embossing station that includes the embossing cylinder according to the invention.

The micro-embossing can thus be done at the same time as the embossing of the motifs Mᵢ is done.

According to a preferred embodiment of the invention, the two kinds of embossing are done on the same ply of the cellulose product.

The micro-embossing makes the product more homogeneous because it keeps significant differences in thickness from developing between the different zones.

An example of an embossing and assembly installation is described below that is shown in FIG. 4 and that makes it possible to produce a sheet composed of two plies, one of which is embossed. This machine includes said rotating cylinder 100, which is made of steel or some other rigid material and is appropriately surface-engraved according to the motif that makes it possible to implement the embossing of the invention. For example, this can be the motif as shown in FIG. 3. A rubber cylinder 110 is mounted in such a way as to rotate on an axis parallel to the first cylinder. It rests on cylinder 100 by means of appropriate jacks, not shown. A first strip of paper is guided from an upstream paying-out device around the cylinder 110 and then between the two cylinders 100 and 110. The sheet then adapts to the relief of the cylinder under the action of the pressure of the rubber. Depending on the pressure of the jacks and the type of rubber, the paper penetrates more or less deeply into the engraved motif. The fineness of the motif is also a parameter that has to be taken into account. The sheet that is pushed onto the cylinder 100 then passes in front of a gluing device 104, which applies glue to the tips of the relief elements. The gluing device 104 in this case is a cylinder with a rigid surface that receives the glue from a chamber with a scraper, for example.

A second strip of paper coming from a second paying-out device, for example, is placed against the first strip by means of a counter cylinder 106. A portion of the film of glue on the first sheet P1 moves onto the parts of the second strip P2 that come into contact with the parts of strip P1 that are in relief. The two plies are thus bonded together by these contact surfaces. The two-ply sheet is then wound into a roll, in particular a log, and moves off to the subsequent treatment stations.

Sheet embossing and assembly installations other than those given here may be used, depending on the product that is to be produced. For example, roller 106 can be replaced by a second embossing unit, and the plies can be bonded tip-to-tip or else nested with a counter cylinder, as is known to anyone skilled in the art. If embossing is done in two stages, a first embossing cylinder, suitably engraved, is placed upstream of cylinder 100.

1. A process for manufacturing and packaging rolls of tissue paper comprising:
embossing at least one sheet of paper in an embossing unit that contains an engraved embossing cylinder;
rolling the sheet into logs;
cutting the logs into individual rolls; and
sending the rolls to a packaging unit, wherein said embossing cylinder includes at least a first zone with a first embossing motif and a second zone with a second embossing motif that is different from the first embossing motif, whereby a first portion of said individual rolls is embossed according to the first embossing motif and a second portion of said individual rolls is embossed according to the second embossing motif.

2. The process according to claim 1, wherein the first zone and the second zone of the embossing cylinder form separate strips that are transverse to an axis of the embossing cylinder.

3. The process according to claim 2, wherein said first zone and said second zone are each separated in an axial direction by an intermediate zone, whereby the cutting of the logs occurs in the intermediate zone.

4. The process according to claim 1, wherein the first zone or the second zone has a width in an axial direction which is less than a width of one roll of the individual rolls.

5. The process according to claim 3, wherein the intermediate zone does not include an embossing motif.

6. The process according to claim 3, wherein the intermediate zone includes an embossing motif.

7. The process according to claim 6, wherein the intermediate zone includes protrusions arranged according to alignments.

8. The process according to claim 6, wherein the embossing motif of the intermediate zone comprises micro-protrusions distributed at a ratio of at least 30 protrusions per cm².

9. The process according to claim 6, wherein the embossing motif of the intermediate zone constitutes a background motif or the motif of the first zone or the second zone.

10. The process according to claim 6, wherein the intermediate zone has a width in an axial direction of the embossing cylinder which is between 1 and 40 mm.

11. The process according to claim 10, wherein a sum of the width of the first zone and the width of the intermediate zone, or a sum of the width of the second zone and the width of the intermediate zone, is substantially equal to a width of one roll of said individual rolls.

12. The process according to claim 1, wherein the logs are stored temporarily before said cutting into the individual rolls.

13. The process according to claim 1, wherein a series of said individual rolls are produced from a single log of said logs.

14. The process according to claim 1, wherein the sheet is embossed prior to being embossed by the embossing cylinder.

15. An embossing cylinder wherein said embossing cylinder includes at least a first zone with a first embossing motif and a second zone with a second embossing motif that is different from the first embossing motif.
